(19) United States
(12) Patent Application Publication
(10) Pub. No.: US 2026/0195801 A1
(43) Pub. Date: Jul. 9, 2026

(54) ELECTRONIC DEVICE AND METHOD FOR RECOMMENDING SIMILAR PRODUCTS USING SAME

(71) Applicant: Samsung Electronics Co., Ltd., Suwon-si (KR)

(72) Inventors: Sangho CHAE, Suwon-si (KR); Seokho YOON, Suwon-si (KR); Jeongsoo LEE, Suwon-si (KR)

(21) Appl. No.: 19/557,820

(22) Filed: Mar. 5, 2026

Related U.S. Application Data
(63) Continuation of application No. PCT/KR2024/011344, filed on Aug. 1, 2024.

(30) Foreign Application Priority Data
Sep. 12, 2023 (KR) 10-2023-0121329
Sep. 20, 2023 (KR) 10-2023-0125907

(51) Int. Cl. G06Q 30/0601

(52) U.S. Cl. CPC G06Q 30/06313; G06Q 30/0625

(57) ABSTRACT

An electronic device is provided. The electronic device includes a display, memory, comprising one or more storage media, storing instructions, and one or more processor operatively connected to the display and the memory wherein the instructions, when executed by the one or more processors individually or collectively, cause the electronic device to identify a first product in response to a search request related to at least one product, identify identification information of a category related to the first product, based on an object embedding model, for multiple objects included in the identification information, identify array information of the multiple objects within the identification information, search for at least one second product related to the first product, based on the array information of the multiple objects, and output, through the display, information related to the searched at least one second product.

### CROSS-REFERENCE TO RELATED APPLICATION(S)

This application is a continuation application, claiming priority under 35 U.S.C. § 365(c), of an International application No. PCT/KR2024/011344, filed on Aug. 1, 2024, which is based on and claims the benefit of a Korean patent application number 10-2023-0121329, filed on Sep. 12, 2023, in the Ministry of Intellectual Property (MOIP), and of a Korean patent application number 10-2023-0125907, filed on Sep. 20, 2023, in the Ministry of Intellectual Property (MOIP), the disclosure of each of which is incorporated by reference herein in its entirety.

### BACKGROUND

### 1. Field

The disclosure relates to an electronic device and a method for recommending a similar product by using the same.

### 2. Description of Related Art

As electronic commerce (e.g., Internet services) such as online shopping malls and social commerce has grown, users have increasingly searched for goods they want to purchase through an online search environment, and have often purchased the searched goods online.

In general, in searching for a specific product on an online network, an electronic device may determine a search word by combining at least one of words, characters, and numbers indicating the specific product, and search for at least one product related to the search word, based on a program and an application related to the searching.

According to an embodiment, the electronic device may search for a similar product (an object or goods) by combining appropriate methods according to a valid information level, and provide the searched similar product to a user. A method according to an embodiment may enable a user to search for a specific product desired by the user and other objects (e.g., similar objects or recommended objects) having a high similarity to the specific product, and appropriately provide a similar object (e.g., a similar product) to the user.

The above information is presented as background information only to assist with an understanding the disclosure. No determination has been made, and no assertion is made, as to whether any of the above might be applicable as prior art with regard to the disclosure.

### SUMMARY

In general, in searching for a specific product on an online network, a user may search for an item desired to be purchased, through a dedicated application program for purchasing goods (e.g., products) or through a search engine. For example, when the user uses, as a search word, a general name (e.g., words referring to a product group, such as computer, refrigerator, washing machine, air conditioner, and television (TV)) of a product desired to be purchased by the user, multiple products may be searched for based on the general name. However, since the number and types of products provided as a search result are diverse, the user may have difficulty in appropriately selecting a product that is actually desired by the user.

In general, in a process of searching for a specific product, an electronic device may detect multiple products determined to be similar to the specific product, based on input characters, numbers, and symbols, and output the detected multiple products as a result value. The electronic device may perform a search operation by using detailed information (e.g., metadata) included in the specific product, and may also perform the search operation, based on an input search word (e.g., characters, numbers, and symbols).

When the electronic device does not perform the search operation, based on specific information (e.g., inventory information, model information, and option information) on a product desired by a user, it may be difficult to provide a similar product and a recommended product in accordance with the user's intent. For example, respective products belonging to the same product group may have different classification systems, and storage forms of identification information (e.g., classification code information) and attribute information may also be different from each other. Accordingly, the electronic device may have difficulty in classifying respective products belonging to the same product group, and may have difficulty in selecting a similar product or a recommended product in accordance with the user's intent, and providing the product to the user.

According to an embodiment, the electronic device may identify, in response to a search request for a first product, identification information (e.g., classification code information) of a product group related to the first product, and apply an object embedding model and provide a recommended item, based on multiple objects (e.g., code information including characters and numbers representing a product-related feature) associated with the identification information, and may select at least one second product (e.g., a similar product) related to the first product. According to an embodiment, in a process of recommending a similar product (e.g., a second product), multiple similar objects associated with identification information of a product group may be used, and a similar product (e.g., a second product) tailored to the user's intent may be provided to the user. A similar product selected in accordance with the user's intent may be provided, and the user's convenience in product searching may be improved.

Aspects of the disclosure are to address at least the above-mentioned problems and/or disadvantages and to provide at least the advantages described below. Accordingly, an aspect of the disclosure is to provide an electronic device which, in a process of searching for a specific product, recommends a similar product related to the specific product in accordance with a user's intent.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, comprising one or more storage media, storing instructions, and one or more processors operatively connected to the display and the memory, wherein the instructions, when executed by the one or more processors individually or collectively, cause the electronic device to identify a first product in response to a search request related to at least one product, identify identification information of a category related to the first product, based on an object embedding model, for multiple objects included in the identification information, identify array information of the multiple objects within the identification information, search for at least one second product related to the first product, based on the array information of the multiple objects, and output, through the display, information related to the searched at least one second product.

In accordance with another aspect of the disclosure, a method for recommending a similar product by an electronic device is provided. The method includes identifying a first product in response to a search request related to at least one product, identifying identification information of a category related to the first product, based on an object embedding model, for multiple objects included in the identification information, identifying array information of the multiple objects within the identification information, searching for at least one second product related to the first product, based on the array information of the multiple objects, and outputting, through a display, information related to the searched at least one second product.

In accordance with another aspect of the disclosure, one or more non-transitory computer-readable storage media storing one or more programs including computer-executable instructions for executing a method for recommending a similar product by an electronic device that, when executed by one or more processors of the electronic device individually or collectively, cause the electronic device to perform operations are provided. The operations include identifying a first product in response to a search request related to at least one product, identifying identification information of a category related to the first product, based on an object embedding model, for multiple objects included in the identification information, identifying array information of the multiple objects within the identification information, searching for at least one second product related to the first product, based on the array information of the multiple objects, and outputting, through a display, information related to the searched at least one second product.

According to an embodiment, an electronic device identifies, in response to a search request for a first product, identification information of a product group related to the first product, and applies an object embedding model, based on multiple objects included in the identification information. The electronic device selects at least one second product (e.g., a similar product or a recommended product) related to the first product, based on the object embedding model, and provides information related to the at least one second product to a user. According to an embodiment, the electronic device provides the at least one second product similar to the first product to the user in accordance to the user's intent, thereby improving the user's convenience related to product searching.

According to an embodiment, the electronic device selects a second product (e.g., a similar product or a recommended product) more rapidly by using the object embedding model, and more efficiently provides the second product which is desired by the user.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram illustrating a method for recommending a similar product related to a specific product according to an embodiment of the disclosure;

FIG. 3 is a block diagram of an electronic device according to an embodiment of the disclosure;

FIG. 4 is a flowchart illustrating a method for recommending a similar product according to an embodiment of the disclosure;

FIG. 5 is a diagram illustrating respective objects included in identification information for a specific product according to an embodiment of the disclosure;

FIG. 6 is a diagram illustrating a first method for calculating a similarity between a first product and a second product, based on first identification information of the first product and second identification information of the second product, according to an embodiment of the disclosure;

FIG. 7 is a diagram illustrating a second method for calculating a similarity between a first product and a second product, based on first identification information of the first product and second identification information of the second product, according to an embodiment of the disclosure; and

FIG. 8 is a diagram illustrating a process of managing an object embedding model and a process of recommending a similar product based on the object embedding model according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

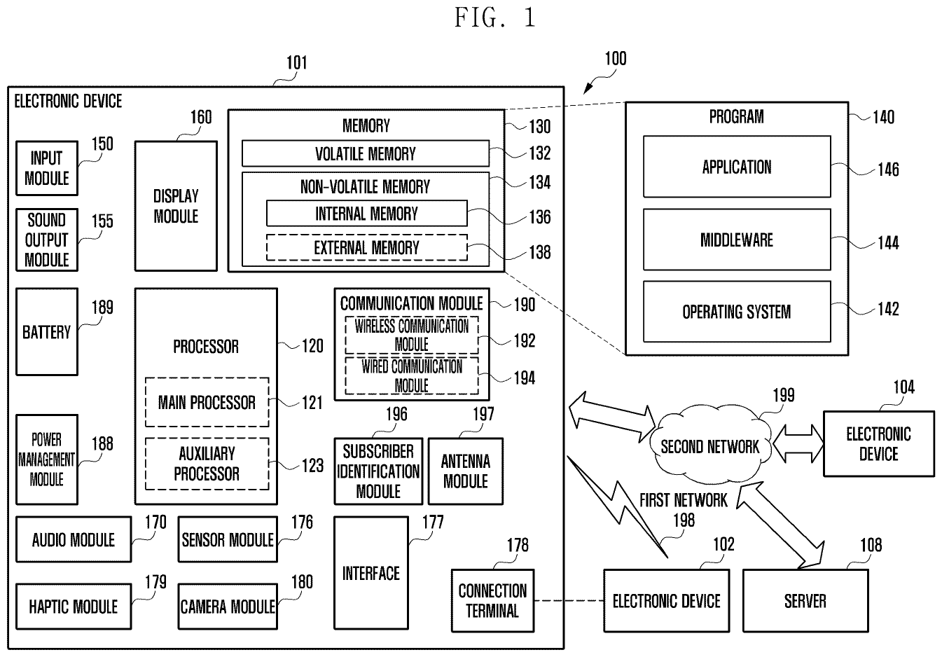

FIG. 1 is a block diagram illustrating an example electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) (e.g., a speaker or a headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). For example, the first antenna may generate a first antenna signal in a first direction based on a linear polarization scheme, and the second antenna may generate a second antenna signal in a second direction different from the first direction based on a linear polarization scheme. For example, the first antenna signal and the second antenna signal may be implemented to be orthogonal to each other. If the first antenna signal is a communication signal in an x-axis direction, the second antenna signal may include a communication signal in a y-axis direction.

According to various embodiments, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

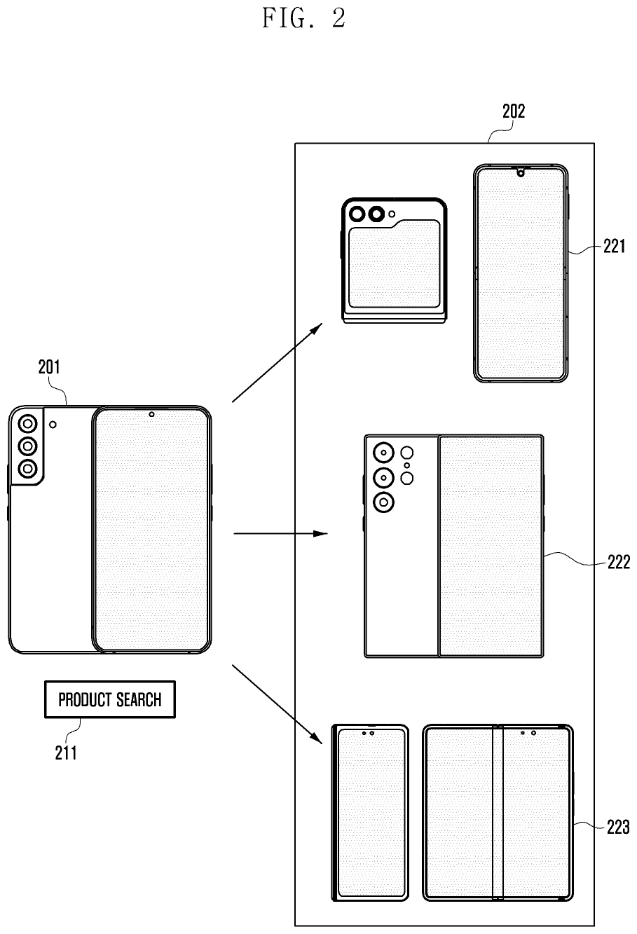

FIG. 2 is a diagram illustrating a method for recommending a similar product related to a specific product according to an embodiment of the disclosure.

Referring to FIG. 2, an electronic device (e.g., the electronic device 101 of FIG. 1) may perform a similar product recommendation program (e.g., a similar product recommendation application, or an application which performs a similar product recommendation function, based on an object embedding model) for searching for and extracting a similar product. For example, the object embedding model may include a specified artificial intelligence model (e.g., an AI model). Referring to FIG. 2, a processor (e.g., the processor 120 of FIG. 1) of the electronic device 101 may apply identification information related to a first product 201 (e.g., a product desired to be searched by a user) to the object embedding model, and search for at least one second product 221, 222, and 223 (e.g., a similar product 202), based on the object embedding model. For example, the processor 120 may generate first code information by encoding identification information for the first product 201, based on the object embedding model. The processor 120 may generate second code information by encoding identification information for the second product 202, based on the object embedding model. The processor 120 may compare the first code information and the second code information, so as to search for a second product 202 which is at least partially similar to the first product 201. The processor 120 may perform a function of product search 211 for the first product 201, search for at least one second product 221, 222, and 223, based on the object embedding model, and provide the at least one second product to a user.

Referring to FIG. 2, the electronic device 101 may execute a similar product recommendation program (e.g., a similar product recommendation application, or an application which performs a similar product recommendation function, based on an object embedding model) installed in memory (e.g., the memory 130 of FIG. 1), and perform the function of product search 211 for the first product 201. For example, in response to performing the function of product search 211, the electronic device 101 may select at least one second product 221, 222, and 223 (e.g., a similar product group 202) which is at least partially similar to the first product 201, and output and display the selected at least one second product 221, 222, and 223 through a display (e.g., the display module 160 of FIG. 1). For example, the electronic device 101 may display the first product 201 and the at least one second product 221, 222, and 223 together through a user interface based on the similar product recommendation program.

According to an embodiment, the processor 120 may identify which product group the first product 201 belongs to, and in detail, what type of product the first product 201 is, based on an object embedding model provided by the similar product recommendation program. According to an embodiment, the object embedding model may classify multiple product groups in accordance with a configured standard, and manage at least one similar product belonging to the same product group, based on a neural network (e.g., a deep neural network (DNN)) having a multi-layer structure. For example, the object embedding model may be included in a machine learning (ML) technique, may be trained based on the user's empirical data, and may perform a prediction to autonomously improve its performance. For example, the object embedding model may include a specified artificial intelligence (AI) model. The object embedding model may be updated based on an execution history of the similar product recommendation program, a search history, and the user's selection history related to a result value (e.g., a similar product). For example, the object embedding model may be managed separately for each account (e.g., user). The processor 120 may encode identification information for a specific product, based on the object embedding model, so as to generate code information corresponding to the specific product. For example, the code information may include classification code information in which multiple objects (e.g., characters and numbers) are arranged according to configured positions. According to an embodiment, the code information may include position information (e.g., location information or array information) for each of the multiple objects within feature and identification information for each of the multiple objects.

According to an embodiment, the processor 120 may search for at least one second product 221, 222, and 223 which belongs to the same product group as the first product 201 and has at least partial similarity to the first product 201, based on the object embedding model, and may output the at least one second product 221, 222, and 223 as a similar product to the first product 201. For example, the electronic device 101 may display the at least one second product 221, 222, and 223 on a user interface (UI) of the similar product recommendation program through the display 160. When the user searches for the first product 201, the electronic device may output the at least one second product 221, 222, and 223 as a recommended product (e.g., a similar product) related to the first product 201 and provide the object to the user.

Referring to FIG. 2, the first product 201 may include a portable user equipment (UE) device such as a smartphone. In response to the product search 211 for the first product 201, the electronic device 101 may select at least one second product 221, 222, and 223 which is at least partially related to the first product 201. For example, a second product group 202 including the at least one second product may differ from the first product 201 in at least one of color, shape, version, form factor, specification, function, weight, price, and inventory status. For example, first code information for the first product 201 and second code information for the second product 202 may differ at least partially from each other. According to an embodiment, in response to the product search 211 for the first product 201, the electronic device 101 may determine priorities according to the object embedding model among multiple second products with remaining inventory, and select at least one second product 221, 222, and 223 in an order of a relatively high priority. For example, the electronic device 101 may display a second product having a relatively higher priority at the top of a similar product (e.g., a recommended product) list, or may display the second product with a highlight effect applied thereto.

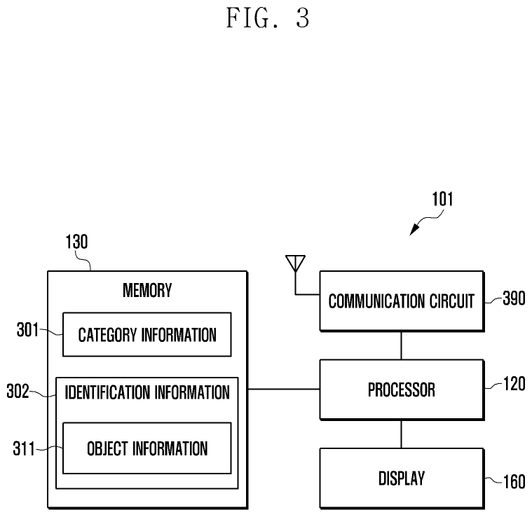

FIG. 3 is a block diagram of an electronic device according to an embodiment of the disclosure.

The electronic device 101 (e.g., the electronic device 101 of FIG. 1) of FIG. 3 may be at least partially similar to the electronic device 101 of FIG. 1, and may further include other embodiments of the electronic device. For example, in response to execution of a similar product recommendation program (e.g., an application program), the electronic device 101 may support a function of searching for a first product (e.g., the first product 201 of FIG. 2) and at least one second product (e.g., the second product group 202 of FIG. 2) related to the first product 201, based on an object embedding model, and displaying the product. For example, the electronic device 101 may encode identification information for the first product 201, based on the object embedding model, so as to generate first code information, and may encode identification information for a second product 202, so as to generate second code information. The electronic device 101 may compare the first code information and the second code information, so as to search for a second product 202 which is at least partially similar to the first product 201. According to an embodiment, the electronic device 101 may display the first product 201 and at least one second product 221, 222, and 223 (e.g., a similar product or a recommended product), based on a user interface according to the similar product recommendation program.

According to an embodiment, the processor 120 may search for at least one second product 221, 222, and 223 which belongs to the same product group as the first product 201 and has at least partial similarity to the first product 201, based on the object embedding model, and may output the at least one second product 221, 222, and 223 as a similar product to the first product 201. For example, the electronic device 101 may display the first product 201 and the at least one second product 221, 222, and 223 on a user interface (UI) of the similar product recommendation program through a display (e.g., the display module 160 of FIG. 1). According to an embodiment, when a user searches for the first product 201, the electronic device 101 may output, through the display 160, the at least one second product 221, 222, and 223 as a recommended product (e.g., a similar product) related to the first product 201, and provide the at least one second product to the user.

Referring to FIG. 3, the electronic device 101 may include a processor (e.g., the processor 120 of FIG. 1), memory (e.g., the memory 130 of FIG. 1), a display (e.g., the display module 160 of FIG. 1), and/or a communication circuit 390 (e.g., the communication module 190 of FIG. 1). In various embodiments, the electronic device 101 may include additional components other than the components illustrated in FIG. 3, or may omit at least one of the components illustrated in FIG. 3. For example, the processor 120 of the electronic device 101 may be operatively, functionally, and/or electrically connected to the memory 130, the display 160, and the communication circuit 390.

According to an embodiment, the processor 120 of the electronic device 101 may control at least one other component (e.g., a hardware or software component) by executing a program (e.g., the program 140 of FIG. 1) stored in the memory 130, and perform various data processing or operations. For example, in response to execution of the similar product recommendation program (e.g., an application program), the processor 120 may support a function of searching for a first product 201 and at least one second product 202 related to the first product 201, based on an object embedding model, and displaying the product. The processor 120 may select a second product 202, based on at least one piece of object information 311 (e.g., code information implemented by using the object embedding model) included in identification information 302 of the first product 201, and display the selected second product 202 through the display 160.

According to an embodiment, the memory 130 may store a similar product recommendation program (e.g., an application program) and an object embedding model for recommending a similar product. According to an embodiment, the memory 130 may store data and/or commands received from other components (e.g., the processor 120, the display module 160, or the communication circuit 390) or generated by other components. According to an embodiment, the processor 120 may search for a first product 201 and at least one second product 202 which is similar to the first product 201, by using the object embedding model stored in the memory 130.

According to an embodiment, the object embedding model may select a first product 201 and a second product 202 having at least partial relevance to the first product 201, based on category information 301 and the identification information 302. For example, the category information 301 may be defined as a product group indicating a kind and type of a specific product. For example, the category information 301 may include information which generally indicates a type of the electronic device 101, such as a TV, a refrigerator, a washing machine, or a dryer. For example, the identification information 302 may include a product name or a model name indicating each product. The identification information 302 may include object information 311 indicating at least one of color, shape, version, form factor, specification, function, weight, price, and inventory status for each product. According to an embodiment, the processor 120 may encode (code) the identification information 302 of a specific product, based on the object embedding model, and may generate code information (e.g., classification code information including multiple objects) corresponding to the specific product. For example, first code information for the first product 201 and second code information for the second product 202 may differ at least partially from each other.

According to an embodiment, the object embedding model may select a first product 201 and a second product 202 having at least partial relevance to the first product 201, based on a description of a product and text information of the product. For example, when a description (e.g., text) and features related to a specific product are input, the object embedding model may generate identification information 302 (e.g., the object information 311) corresponding to the specific product, based on the input description and features. For example, the processor 120 may generate first code information corresponding to the first product 201, based on a description and features related to the first product 201. For another example, the processor 120 may generate second code information corresponding to the second product 202, based on a description and features related to the second product 202. According to an embodiment, the processor 120 may select at least one second product 202 which is at least partially similar to the first product 201, by using the first code information and the second code information generated based on the object embedding model.

According to an embodiment, the object embedding model may generate identification information 302 (e.g., the object information 311) corresponding to a specific product by combining at least one of the category information 301, the identification information 302, a description for the product, and text information of the product. For example, when a search request for a specific product is received, the processor 120 may apply a description of the product, text information of the product, category information of the product, and identification information of the product according to the search request to the object embedding model, and may generate identification information corresponding to the specific product, based on the object embedding model.

According to an embodiment, the processor 120 may identify a first product 201, based on at least one of a description, text information, category information, and identification information corresponding to at least one product, according to the search request.

According to an embodiment, in response to a product search request for a first product 201, the processor 120 may select at least one second product 202 which is at least partially similar to the first product 201, based on the category information 301 and the identification information 302. For example, the processor 120 may identify identification information 302 corresponding to the first product 201, and identify object information 311 for each of multiple objects included in the identification information 302. The object information 311 may include array information (e.g., location information or position information) for each of the objects within the identification information 302. For example, the object information 311 may include array information for the multiple objects included in the identification information 302. The array information may include information related to an arrangement location, an arrangement order, and an object array order with respect to the multiple objects constituting the identification information 302. According to an embodiment, the processor 120 may search for at least one second product 202 having at least partial relevance to the first product 201, based on array information (e.g., an arrangement location, an arrangement order, and an array order) for each of the objects included in the identification information of the first product 201. According to an embodiment, the processor 120 may provide the first product 201 and the at least one second product 202 together to the user.

According to an embodiment, the processor 120 may convert a processed image signal, data signal, and control signal, based on the object embedding model, and may display information related to the processed signal through the display 160. For example, the processor 120 may display a first product 201 and at least one second product 202 having at least partial relevance to the first product 201, based on a user interface generated by a similar product recommendation program (e.g., an application program).

According to an embodiment, the processor 120 may establish a direct (e.g., wired) communication channel or a wireless communication channel with an external electronic device (e.g., the electronic device 102, the electronic device 104, or the server 108) through the communication circuit 390 (e.g., the communication module 190 of FIG. 1), and perform network communication through the established communication channel.

According to an embodiment, in a process of searching for a similar product group (e.g., the second product 202 or the at least one second product 221, 222, and 223) for the first product 201, the processor 120 of the electronic device 101 may identify category information 301 (e.g., a product group, a product category, and a product type) related to the first product 201, and identify identification information 302 corresponding to the identified category information 301. For example, the identification information 302 may include metadata information and attribute information of a corresponding product (e.g., the first product 201). For example, the first product 201 and the second product 202 (e.g., the at least one second product 221, 222, and 223), which belong to the same category (e.g., mobile devices or smartphones), may include at least partially the same identification information 302. For example, the processor 120 may generate first code information by encoding identification information for the first product 201, based on the object embedding model. The processor 120 may generate second code information by encoding identification information for the second product 202, based on the object embedding model. The processor 120 may compare the first code information and the second code information, so as to select the second code information which is at least partially similar to the first code information. According to an embodiment, the processor 120 may search for at least one second product 221, 222, and 223, based on first identification information for the first product 201.

According to an embodiment, the processor 120 may identify first identification information corresponding to the first product 201, and may select at least one second product 221, 222, and 223 belonging to the same category (e.g., a product group), based on the identified first identification information. For example, each of the at least one second product 221, 222, and 223 may include second identification information. The first identification information for the first product 201 and the second identification information for each of the second products 221, 222, and 223 may include at least partially the same objects (e.g., the object information 311).

According to an embodiment, the identification information 302 may include multiple objects (e.g., objects or the object information 311) and may be implemented in a form representing array information for each of the multiple objects. For example, the object information 311 included in the identification information 302 may include one of at least one character and at least one numeral, and may include a code value (e.g., code information or classification code information) indicating a feature of a product. The first product 201 may include first identification information and first code information corresponding to the first identification information, and the second product 202 may include second identification information and second code information corresponding to the second identification information. According to an embodiment, the object information 311 included in the identification information 302 may be configured to include at least one of at least one character, at least one numeral, and at least one symbol. The object information 311 may include array information for at least one of at least one character, at least one numeral, and at least one symbol.

According to an embodiment, the processor 120 may apply the array information for each of the objects included in first object information of the first product 201 to the object embedding model, and select at least one second product 202 having relevance to the first product 201. For example, the processor 120 may select second object information (e.g., second code information) which is at least partially different from the first object information (e.g., first code information), based on the array information for each of the objects included in the first object information. The processor 120 may calculate a similarity between the first product 201 and the at least one second product 202, and select the at least one second product 202, based on the calculated similarity. For example, the at least one second product 202 may include a product in the same product group having a certain level (e.g., a configured threshold value) of similarity with respect to the first product 201.

According to an embodiment, the processor 120 may configure a weight for the object information 311, and operate the object embedding model to which the weight is applied. In selecting at least one second product 202, the processor 120 may apply a relatively high weight to an object (e.g., at least one of color, shape, version, form factor, specification, function, weight, price, and inventory status) having a high importance. For example, when the user searches for the first product 201 and desires a second product 202 which belongs to the same product group as the first product but has a different form factor, the processor 120 may configure such that a relatively high weight is assigned to an object (e.g., a character or a number) indicating a “form factor.” For another example, when the user searches for the first product 201 and desires a second product 202 which belongs to the same product group as the first product and supports a specific function, the processor 120 may configure such that a relatively high weight is assigned to an object indicating the “specific function.” According to an embodiment, the processor 120 may configure a different weight for each of the objects included in the object information 311.

According to an embodiment, each of the multiple objects may include at least one of category information, type information, option information, function information, color information, shape information, manufacturing date information, and manufacturing country information related to a corresponding product. According to an embodiment, information indicated by each of the objects is not limited to the above-described information and may be variously configured by a manufacturer and a developer. According to an embodiment, the number of objects constituting the object information 311 is not limited to a specific number.

According to an embodiment, the processor 120 may compare first code information of the first product 201 and second code information of the second product 202, and calculate a similarity of the second product 202 based on the first product 201, based on at least partially matching code information between the first code information and the second code information. For example, the similarity of the second product 202 may be information obtained by quantifying how similar the second product 202 is with respect to the first product 201. The similarity of the second product 202 may be information obtained by quantifying relevance of the second product 202 to the first product 201 in a state reflecting user-preferred criteria (e.g., in a state in which a weight is applied for each object). According to an embodiment, the processor 120 may apply a weight configured in the first code information and the second code information, and calculate a similarity in a state in which the weight is applied.

According to an embodiment, the processor 120 may select a second product 202 which is at least partially related to the first product 201, based on the object embedding model, and provide the first product 201 and the selected second product 202 to the user. For example, the user may select a product having a relatively higher level of interest from among the first product 201 and the second product 202. According to an embodiment, the processor 120 may identify a product selected by the user among similar products (e.g., the second product 202) recommended based on the object embedding model, and update the object embedding model by using information related to the similar product selected by the user. For example, when it is identified that the user preferentially selects a product having a different form factor among the recommended similar products, the processor 120 may update the object embedding model such that, when searching for the first product 201, a second product 202 having a form factor different from that of the first product 201 is displayed relatively earlier.

According to an embodiment, an electronic device (e.g., the electronic device 101 of FIG. 3) may include a display (e.g., the display module 160 of FIG. 1 or the display 160 of FIG. 3), memory (e.g., the memory 130 of FIGS. 1 and 3), and a processor (e.g., the processor 120 of FIGS. 1 and 3) operatively connected to the display 160 and the memory 130. According to an embodiment, the processor 120 may identify a first product in response to a search request related to at least one product. The processor 120 may identify identification information (e.g., the identification information 302 of FIG. 3) of a category related to the first product (e.g., the first product 201 of FIG. 2), based on the object embedding model. With respect to multiple objects included in the identification information 302, the processor 120 may identify array information of the multiple objects within the identification information 302. The processor 120 may search for at least one second product 202 related to the first product 201, based on the array information of the multiple objects. The processor 120 may output, through the display 160, information related to the searched at least one second product 202.

According to an embodiment, the processor 120 may calculate a similarity corresponding to the at least one second product 202, based on the array information of the multiple objects. The processor 120 may search for the at least one second product 202, based on the calculated similarity.

According to an embodiment, each of the objects included in the identification information 302 may be configured to include one of at least one character, at least one numeral, and at least one symbol.

According to an embodiment, the processor 120 may configure a weight corresponding to each of the objects included in the identification information 302. In response to a situation in which first code information corresponding to the first product 201 and second code information corresponding to the second product 202 at least partially match each other, the processor 120 may apply a weight configured to correspond to the matched code information.

According to an embodiment, each of the multiple objects may include information related to at least one product, the information indicating at least one of category information of the product, type information of the product, option information of the product, function information of the product, color information of the product, manufacturing date information of the product, and manufacturing country information of the product.

According to an embodiment, when a first object is not included in the multiple objects, the processor 120 may identify a second object related to the first object, based on the object embedding model. The processor 120 may search for at least one second product 202 which at least partially matches the identified second object, based on the object embedding model.

According to an embodiment, the processor 120 may identify a weight configured based on array information for each of the objects. The processor 120 may apply a weight configured to correspond to each of the multiple objects. The processor 120 may search for the at least one second product 202, based on a similarity according to the configured weight.

According to an embodiment, in response to information related to the at least one second product 202 being output, the processor 120 may update the object embedding model, based on the at least one second product 202.

According to an embodiment, the electronic device 101 may further include a communication circuit 190 for establishing a communication connection with an external electronic device (e.g., the server 108 of FIG. 1). The processor 120 may transmit, to the external electronic device 108 through the communication circuit 190, product information related to the first product 201. The processor 120 may receive at least one second product 202 related to the first product 201, the at least one second product being searched based on an object embedding model of the external electronic device 108. The processor 120 may output information related to the received at least one second product 202.

According to an embodiment, the processor 120 may identify the first product 201, based on at least one of a description, text information, category information, and identification information corresponding to the at least one product, according to the search request.

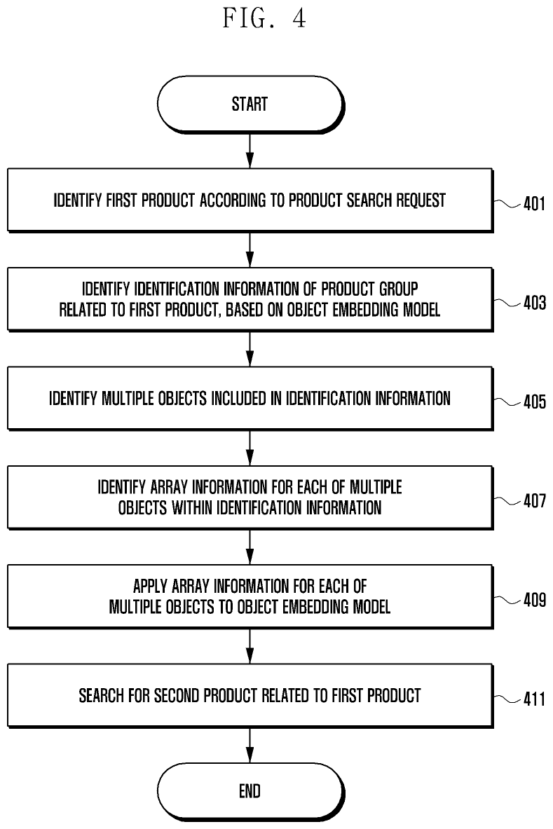

FIG. 4 is a flowchart illustrating a method for recommending a similar product according to an embodiment of the disclosure.

In the following embodiments, respective operations may be performed sequentially, but is not necessarily performed sequentially. For example, the order of the operations may be changed, and at least two operations may be performed in parallel.

According to an embodiment, operations 401 to 411 may be understood as being performed by a processor (e.g., the processor 120 of FIGS. 1 and 3) of an electronic device (e.g., the electronic device 101 of FIGS. 1 and 3).

The electronic device 101 of FIG. 4 may be at least partially similar to the electronic device 101 of FIG. 3, and may further include other embodiments of the electronic device 101.

According to an embodiment, the electronic device 101 may be in a state in which a similar product recommendation program (e.g., a similar product recommendation application, or an application which performs a similar product recommendation function based on an object embedding model) is stored in memory (e.g., the memory 130 of FIG. 3). When performing a product search function (e.g., the product search 211 of FIG. 2 or a product search function for a first product (e.g., the first product 201 of FIG. 2) based on the similar product recommendation program, a processor (e.g., the processor 120 of FIG. 3) of the electronic device 101 may search for the first product 201 and a second product (e.g., the second product 202, the at least one second product 221, 222, and 223, or a group of similar products of FIG. 2) which is at least partially similar to the first product 201, based on an object embedding model. For example, the processor 120 may generate first code information by encoding identification information for the first product 201, based on the object embedding model. The processor 120 may generate second code information by encoding identification information for the second product 202, based on the object embedding model. The processor 120 may compare the first code information and the second code information, so as to search for the second product 202 which is at least partially similar to the first product 201. According to an embodiment, when a product search function for the first product 201 is performed by a user's request, the electronic device 101 may select the first product 201 and the second product 202 which is at least partially similar to the first product 201, based on the object embedding model, and provide the object to the user. The electronic device 101 may display the first product 201 together with the second product 202 which is at least partially similar to the first product 201, based on a user interface of the similar product recommendation program.

In operation 401, the processor 120 may identify the first product 201 according to a product search request (e.g., the product search 211 of FIG. 2). For example, while the similar product recommendation program is being executed, the electronic device 101 may identify a search request signal for a first product 201 and at least one second product 202 having relevance to the first product 201. The processor 120 may identify the first product 201 for which a product search has been requested.

In operation 403, the processor 120 may identify identification information (e.g., the identification information 302 of FIG. 3) of a product group (e.g., a kind or a type of a product and the category information 301 of FIG. 3) related to the first product 201, based on the object embedding model. For example, the first product 201 may include category information 301 to which the first product 201 belongs and identification information 302 indicating a detailed specification (spec) (e.g., a function) of the first product 201. In response to the product search request for the first product 201, the processor 120 may identify the identification information 302 corresponding to the first product 201. For example, the processor 120 may generate first code information corresponding to the first product 201, based on the object embedding model.

In operation 405, the processor 120 may identify multiple objects (e.g., the object information 311 of FIG. 3) included in the identification information 302. For example, the identification information 302 may include multiple objects indicating at least one of color, shape, version, form factor, specification, function, weight, price, and inventory status for a product. The identification information 302 indicates detailed information for the product, and may be defined as a product name or a model name. The processor 120 may encode (or code) the identification information 302 of the first product 201, and generate the first code information (e.g., classification code information including multiple objects) corresponding to the first product 201.

In operation 407, the processor 120 may identify array information for each of the multiple objects within the identification information 302 (e.g., code information or first code information). For example, each of the objects included in the identification information 302 may be in a state in which a storage position and a storage order are preconfigured. For example, within the identification information 302, a first object positioned first in the order and a second object positioned second in the order may indicate a product group (e.g., the category information 301) of the first product 201. For example, the processor 120 may identify the product group of the first product 201, based on the first object and the second object, within the identification information 302.

In operation 409, the processor 120 may apply array information for each of the multiple objects to the object embedding model. For example, the processor 120 may apply first identification information of the first product 201, the first identification information including the array information for each of the objects, to the object embedding model, and may search for at least one second product 202 having at least partial relevance to the first product 201, based on the object embedding model.

In operation 411, the processor 120 may search for a second product 202 related to the first product 201. For example, the processor 120 may calculate a similarity between the first product 201 and the second product 202, based on first identification information (e.g., first code information) of the first product 201 and second identification information (e.g., second code information) of the second product 202, and determine whether the second product 202 has a certain degree of relevance to the first product 201, based on the similarity. According to an embodiment, the processor 120 may select second products 202 in an order of relatively high similarity, and may display the selected second products 202.

According to an embodiment, the electronic device 101 may configure a weight corresponding to each of the objects constituting identification information (e.g., code information), and may apply the configured weight to each of the objects in calculating a similarity. For example, when the user has a high level of interest in various form factors for the first product 201, the electronic device 101 may configure a relatively high weight to be applied to an object indicating the form factor. According to an embodiment, in a process of calculating a similarity, the electronic device 101 may apply a weight to each of the objects, and calculate a similarity between the first product 201 and the second product 202 in a state in which the weight is applied. The electronic device 101 may output and display the second product 202 having a relatively high similarity.

According to an embodiment, the electronic device 101 may identify a first product according to a product search request, and determine whether inventory of the first product is available, based on identification information of the first product. For example, when inventory of the first product is not available, the electronic device 101 may search for at least one second product having identification information (e.g., code information) which at least partially matches the identification information of the first product, and having available inventory.

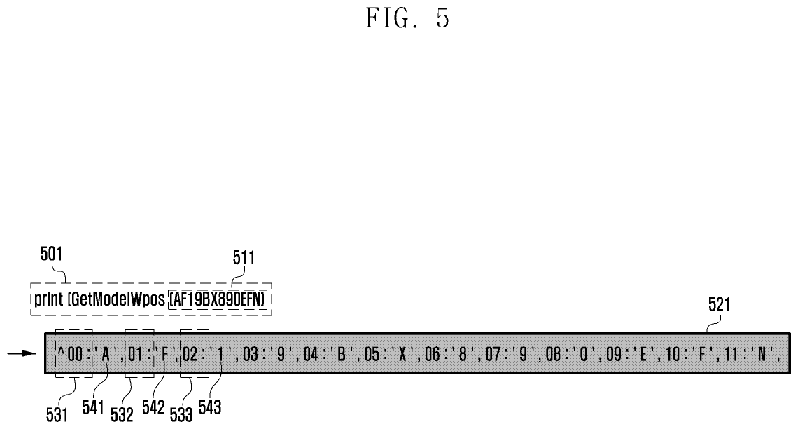

FIG. 5 is a diagram illustrating respective objects included in identification information for a specific product according to an embodiment of the disclosure.

In the description related to FIG. 5, the electronic device 101 may be at least partially similar to the electronic device 101 of FIG. 3, and may further include other embodiments of the electronic device 101.

Referring to FIG. 5, a processor (e.g., the processor 120 of FIG. 3) of the electronic device 101 may identify identification information 511 (e.g., the identification information 302 of FIG. 3) for a specific product (e.g., the first product 201 of FIG. 2) and code information 521 implemented by encoding the identification information 511. The processor 120 may input the identification information 511 to the coding function 501, and may identify the code information 521 indicating the identification information 511. For example, the identification information 511 may be in a form in which at least one character and at least one numeral are combined and arranged. Referring to FIG. 5, the identification information 511 of the first product 201 may be in a form of “AF19BX890EFN” in which a total of 12 characters and numbers are combined.

According to an embodiment, the processor 120 may encode (code) the identification information 302 of a specific product, based on an object embedding model, and may generate code information (e.g., classification code information including multiple objects) corresponding to the specific product. For example, the processor 120 may encode (code) the identification information 511 of the first product 201, based on the object embedding model, and implement the identification information 511 as the code information 521.

Referring to FIG. 5, the processor 120 may apply the identification information 511, based on a functional expression provided in the following (Table 1), and generate the code information 521 in a form in which at least one character and at least one numeral are combined.

TABLE 1
Let a character C at the position PP be P_ENC(C) = PP: ‘C’
If C is the first character, add \hat{ } at the front
Let P_ENC(model_code)=P_ENC(C1,C2,C3...CN)=”\hat{ }P_ENC(C1),
P_ENC(C2), P_ENC(C3),...P_ENC(CN)

According to an embodiment, the functional expression of Table 1 may be used to encode the identification information 511 to generate the code information 521. According to an embodiment, in generating the code information 521, various functional expressions and mathematical expressions may be applied, and the disclosure is not limited to the functional expression of Table 1.

Referring to FIG. 5, the code information 521 may include each of objects 541, 542, and 543 constituting the identification information 511 (e.g., “AF19BX890EFN”) and array information 531, 532, and 533 of the objects. For example, a first object of the code information 521 illustrated in FIG. 5 may be a character “A” 541, and first array information 531 of the character “A” 541 may be “\hat{ }00”. “\hat{ }” may be a symbol indicating that the object is the first object. A second object of the code information 521 may be a character “F” 542, and second array information 532 of the character “F” 542 may be “01”. A third object of the code information 521 may be a number “1” 543, and third array information 533 of the number “1” 543 may be “02”. According to an embodiment, the code information 521 may include the array information 531, 532, and 533 for the objects included in the identification information 511 and object information 541, 542, and 543 for the objects, and may be implemented in a form of being arranged according to an order of the objects. According to an embodiment, the code information 521 is not limited to the form illustrated in FIG. 5 and may be implemented in various forms.

According to an embodiment, the processor 120 may assign a weight to each of the objects constituting the code information 521. For example, when a weight assigned to the first object is relatively greater than a weight assigned to the second object, the processor 120 may increase the number of characters included in the first object. The processor 120 may convert the character “A” 541, which is the first object, to “AAAA” and apply a weight configured for the first object. For example, when the character “F” 542, which is the second object, is converted into “FF”, this may indicate that the first object (“AAAA”) has a relatively higher importance (e.g., priority) than the second object (“FF”). According to an embodiment, the processor 120 may assign a different weight corresponding to each of the objects constituting the code information 521, and determine the number of characters for each of the objects, based on the assigned weight. According to an embodiment, the processor 120 may select a second product 202 which is at least partially similar to the first product 201, based on the code information 521 to which the weight is applied.

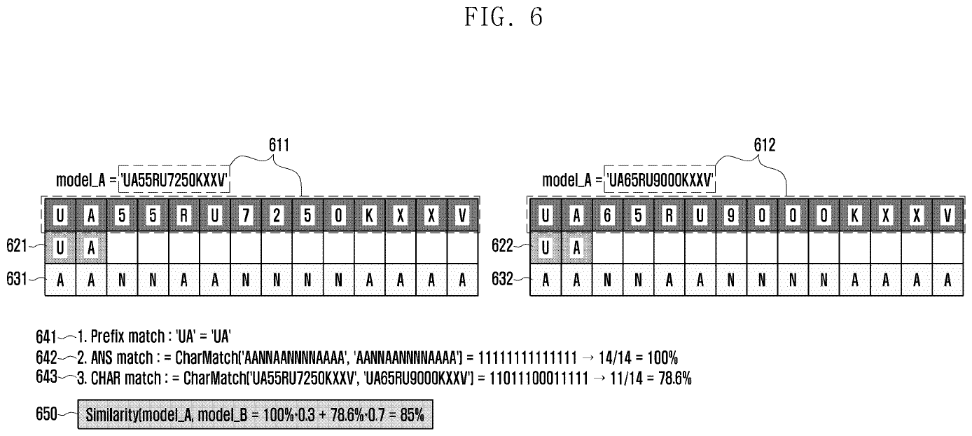

FIG. 6 is a diagram illustrating a first method for calculating a similarity between a first product and a second product, based on first identification information of the first product and second identification information of the second product, according to an embodiment of the disclosure.

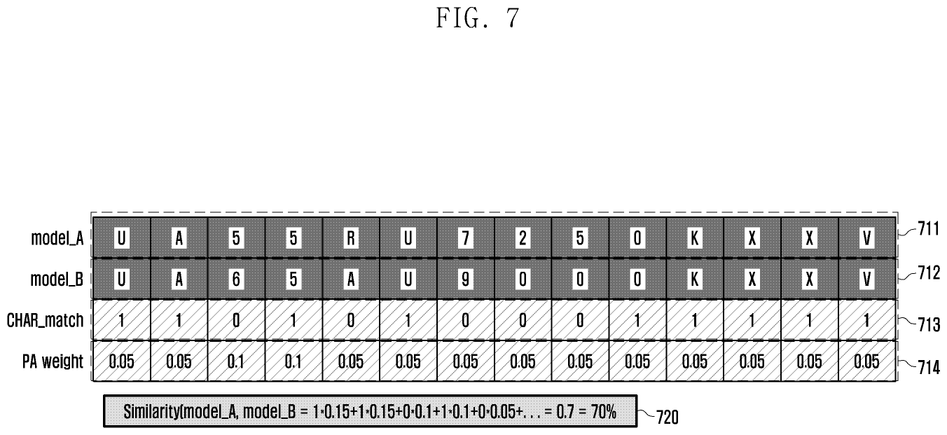

FIG. 7 is a diagram illustrating a second method for calculating a similarity between a first product and a second product, based on first identification information of the first product and second identification information of the second product, according to an embodiment of the disclosure.

In the description related to FIGS. 6 and 7, the electronic device 101 may be at least partially similar to the electronic device 101 of FIG. 3, and may further include other embodiments of the electronic device 101.

Referring to FIG. 6, a processor (e.g., the processor 120 of FIG. 3) of the electronic device 101 may compare first identification information 611 of a first product (e.g., the first product 201 of FIG. 2) and second identification information 612 of a second product (e.g., the second product 202 of FIG. 2). For example, the first identification information 611 may be in a form of “UA55RU7250KXXV” in which a total of 14 characters and numbers are combined, and the second identification information 612 may be in a form of “UA65RU9000KXXV” in which a total of 14 characters and numbers are combined. For example, the first identification information 611 may be implemented in a form in which a first object to a 14th object are sequentially arranged. The first object may be a character “U”, and the 14th object may be a character “V”. The first identification information 611 and the second identification information 612 illustrated in FIG. 6 are exemplarily determined, and the disclosure is not limited thereto.

Referring to FIG. 6, with respect to the first identification information 611, a first object may be a character “U”, and a second object may be a character “A”. Referring to FIG. 6, with respect to the second identification information 612, a first object may be a character “U”, and a second object may be a character “A”. For example, the first object and the second object included in the identification information may be defined as “product group information” for a product. First product group information 621 of the first identification information 611 may be “UA”, and second product group information 622 of the second identification information 612 may be “UA”. The first product 201 and the second product 202 may be products belonging to the same product group (e.g., the category information 301 of FIG. 3).

Referring to FIG. 6, the first identification information 611 may be determined based on at least one character and at least one numeral. For example, a first array structure 631 of the first identification information 611 may have a structure of “AANNAANNNNAAAA”, and a second array structure 632 of the second identification information 612 may have a structure of “AANNAANNNNAAAA”. The first identification information 611 and the second identification information 612 may be implemented to have substantially the same structure.

Referring to FIG. 6, the processor 120 may compare the first identification information 611 of the first product 201 and the second identification information 612 of the second product 202 in various manners, and calculate a similarity between the first product 201 and the second product 202. The processor 120 may compare the first product group information 621 of the first identification information 611 and the second product group information 622 of the second identification information 612 by using a first matching condition 641 (prefix match), and may identify that the first product 201 and the second product 202 belong to substantially the same product group. The processor 120 may compare the first array structure 631 of the first identification information 611 and the second array structure 632 of the second identification information 612 by using a second matching condition 642 (ANS match). For example, the first identification information 611 and the second identification information 612 may be implemented with a total of 14 objects and may have substantially the same array structure. The processor 120 may identify that a matching rate for the second matching condition 642 is about 100%. The processor 120 may identify a relevance between the first product 201 and the second product 202 by using a third matching condition 643 (CHAR match). For example, the processor 120 may identify that a matching rate between an object included in the first identification information 611 and an object included in the second identification information 612 is about 78.6%. The processor 120 may identify that a total of 11 objects among a total of 14 objects constituting the first identification information 611 and the second identification information 612 match each other. The processor 120 may configure a threshold value in relation to the third matching condition 643, and in response to a condition in which the matching rate exceeds the configured threshold value, calculate a similarity between the first product 201 and the second product 202.

According to an embodiment, in calculating the similarity, the processor 120 may configure weights for the second matching condition 642 and the third matching condition 643, respectively, and may calculate the similarity between the first product 201 and the second product 202 by reflecting the configured weights. Referring to FIG. 6, a weight of about 0.3 is configured for the second matching condition 642, and a weight of about 0.7 is configured for the third matching condition 643, but the disclosure is not limited thereto. According to an embodiment, based on a first similarity calculation formula 650, the processor 120 may apply a weight of about 0.3 to a matching rate of about 100% according to the second matching condition 642, and apply a weight of about 0.7 to a matching rate of about 78.6% according to the third matching condition 643. Referring to FIG. 6, the processor 120 may identify that the similarity between the first product 201 and the second product 202 is about 85%. For example, a high similarity may indicate a high degree of relevance between the first product 201 and the second product 202.

According to an embodiment, the processor 120 may select at least one second product 202 in response to a product search request for the first product 201, and calculate a similarity between the first product 201 and the at least one second product 202. The processor 120 may determine a priority for the at least one second product 202, based on the calculated similarity. For example, the higher the similarity between the first product 201 and the second product 202, the higher the priority of the second product 202 may be. According to an embodiment, in selecting a similar product or a recommended product for the first product 201, the processor 120 may preferentially display the second product 202 having a relatively high priority. The processor 120 may select, with respect to the first product 201, the second product 202 having a relatively high similarity, and may display the selected second product 202 through a display (e.g., the display 160 of FIG. 3).

According to an embodiment, in response to the product search request for the first product 201, the electronic device 101 may preferentially provide, to a user, a product having a high similarity with respect to the first product 201.

Referring to FIG. 7, the processor 120 of the electronic device 101 may compare first identification information 711 of the first product 201 and second identification information 712 of the second product 202. For example, the first identification information 711 may be in a form of “UA55RU7250KXXV” in which a total of 14 characters and numbers are combined, and the second identification information 712 may be in a form of “UA65AU9000KXXV” in which a total of 14 characters and numbers are combined. The first identification information 711 and the second identification information 712 may be implemented in a form in which a first object to a 14th object are sequentially arranged. Each of the first identification information 711 and the second identification information 712 may include a total of 14 objects.

Referring to FIG. 7, the processor 120 may identify a third matching condition 713 (CHAR match) between the first identification information 711 and the second identification information 712. The processor 120 may configure a weight 714 (PA weight) differently for each object individually. For example, a weight of about 0.05 may be configured for a first object “U” and a second object “A”, and a weight of about 0.1 may be configured for a third object and a fourth object.

According to an embodiment, in calculating a similarity, the processor 120 may identify a weight configured to correspond to each of the objects, based on the third matching condition 643, and may calculate a similarity between the first product 201 and the second product 202 by reflecting the configured weight to each of the objects. Referring to FIG. 7, for a specific object, a relatively high weight has been reflected, and this may mean that a similar product and a recommended product are selected primarily based on object information with a high weight reflected. For example, when a user is highly interested in similar products having the same size, a weight for object information indicating a size of a product may be configured to be relatively high, and during a search for similar products, a similar product having the same size as that of the first product may be selected. For example, a high weight configured for a specific object may indicate that the user has configured a feature of a product corresponding to the specific object as a main search condition.

According to an embodiment, the processor 120 may select at least one second product 202 in response to a product search request for the first product 201, and calculate a similarity between the first product 201 and the at least one second product 202. In calculating the similarity, the processor 120 may configure a different weight for each object. For example, a relatively high weight configured for a specific object may indicate that a similar product and a recommended product are selected by preferentially considering a feature and a function corresponding to the corresponding specific object. The processor 120 may determine a priority for the at least one second product 202 (e.g., a similar product or a recommended product), based on the calculated similarity. For example, the higher the similarity between the first product 201 and the second product 202, the higher the priority of the second product 202 may be.

According to an embodiment, in selecting a similar product or a recommended product for the first product 201, the processor 120 may preferentially display the second product 202 having a relatively high priority. The processor 120 may select, with respect to the first product 201, the second product 202 having a relatively high similarity, and may display the selected second product through a display (e.g., the display 160 of FIG. 3).

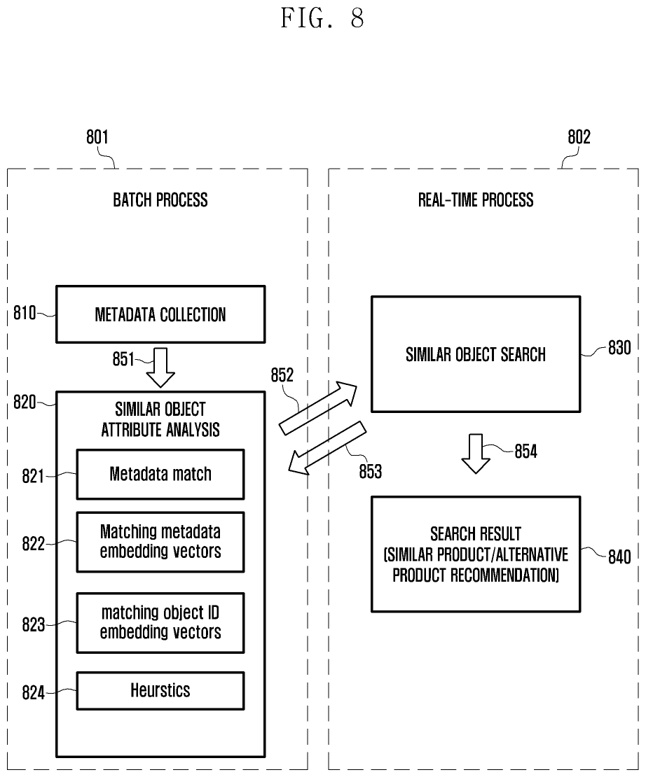

FIG. 8 is a diagram illustrating a process of managing an object embedding model and a process of recommending a similar product based on the object embedding model according to an embodiment of the disclosure.

In the description related to FIG. 8, the electronic device 101 may be at least partially similar to the electronic device 101 of FIG. 3, and may further include other embodiments of the electronic device 101.

According to an embodiment, the electronic device 101 may be in a state in which a similar product recommendation program (e.g., a similar product recommendation application, or an application which performs a similar product recommendation function based on an object embedding model) is stored in memory (e.g., the memory 130 of FIG. 3). When performing a product search function (e.g., the product search 211 of FIG. 2 or a product search function for a first product (e.g., the first product 201 of FIG. 2) based on the similar product recommendation program, a processor (e.g., the processor 120 of FIG. 3) of the electronic device 101 may search for the first product 201 and a second product (e.g., the second product 202, the at least one second product 221, 222, and 223, or a group of similar products of FIG. 2) which is at least partially similar to the first product 201, based on an object embedding model. According to an embodiment, when a product search function for the first product 201 is performed by a user's request, the electronic device 101 may compare and analyze first code information corresponding to the first product 201 generated based on the object embedding model and second code information corresponding to the second product 202 generated based on the object embedding model. The electronic device 101 may identify the first code information of the first product 201 and second code information which is at least partially similar to the first code information, select the second product 202 corresponding to the second code information, and provide a result of the selection to the user. The electronic device 101 may recommend the first product 201 together with the second product 202 (e.g., a similar product or an alternative product) which is at least partially similar to the first product 201, based on a user interface of the similar product recommendation program.

Referring to FIG. 8, the processor 120 of the electronic device 101 may perform a first processing process 801 (e.g., a batch platform, BATCH PROCESS) for managing an object embedding model and a second processing process 802 (e.g., a real-time platform, REAL-TIME PROCESS) for selecting a similar product and providing the product to a user.

The first processing process 801 may be divided into a first operation 810 (e.g., metadata collection) and a second operation 820 (e.g., similar object attribute analysis), and the object embedding model may be managed by performing the first operation 810 and the second operation 820. For example, the first operation 810 may include an operation of collecting metadata (e.g., the category information 301 of FIG. 3 and the identification information 302 of FIG. 3) related to a product by a developer and a manager. When metadata related to at least one product is input, the electronic device 101 may collect the metadata, based on the similar product recommendation program. In operation 851, the processor 120 may perform the second operation 820, based on the collected metadata. For example, the second operation 820 may include an operation of matching and managing at least partially similar products by using the collected metadata. The electronic device 101 may match a first product (e.g., the first product 201 of FIG. 2) and a second product (e.g., the second product 202 of FIG. 2) which is at least partially similar to the first product 201, based on the object embedding model. For example, when a product search request for the first product 201 is identified, the electronic device 101 may select a second product 202 which at least partially matches with respect to the first product 201, and may output the selected second product 202.

Referring to FIG. 8, in the second operation 820, one of about four processing manners 821, 822, 823, and 824 is performed, but the disclosure is not limited thereto.

In the second operation 820, a first manner 821 (metadata match) may be a manner of managing the first product 201 and the second product 202 so that the first product and the second product match each other, in response to a situation in which metadata (e.g., the object information 311 included in the identification information 302) between the first product 201 and the second product 202 matches each other. For example, the processor 120 may search for at least one second product 202 having the same category information based on the category information 301 of the first product 201, and may select the second product 202 in which the identification information 302 of the first product 201 and the identification information 302 of the at least one second product 202 at least partially match. The processor 120 may manage the first product 201 and the second product 202 so that the first product and the second product match each other, based on the object embedding model. For example, the processor 120 may identify whether first code information for the first product 201 generated based on the object embedding model and second code information for the second product 202 generated based on the object embedding model match each other, and may select the second product 202 corresponding to the second code information which at least partially matches the first code information of the first product 201.

In the second operation 820, a second manner 822 (matching metadata embedding vectors) may be a manner of determining whether the first product 201 and the second product 202 match each other by comparing and analyzing the first product 201 and the second product 202 in a situation in which metadata (e.g., the identification information 302) between the first product 201 and the second product 202 does not partially match (e.g., a situation in which the category information 301 does not match each other). For example, when some objects included in the metadata are missing or an error occurs, the processor 120 may generate other objects which replace the some objects, based on the object embedding model. The processor 120 may compare the first product 201 and the second product 202, and manage the first product 201 and the second product 202 so that the first product and the second product match each other when a configured matching condition is satisfied.

In the second operation 820, a third manner 823 (matching object embedding vectors) may be a manner of determining whether the first product 201 and the second product 202 match each other by comparing first identification information (e.g., the first identification information 611 of FIG. 6) for the first product 201 and second identification information (e.g., the second identification information 612 of FIG. 6) for the second product 202 with each other in a situation in which metadata (e.g., the identification information 302) between the first product 201 and the second product 202 does not at least partially match. For example, the processor 120 may determine whether the second identification information 612 matches the first identification information, based on object information included in the first identification information 611 and array information for the object. The processor 120 may encode the first identification information to generate first code information (e.g., the code information 521 of FIG. 5), and may encode the second identification information to generate second code information. The processor 120 may manage the first product 201 and the second product 202 so that the first product and the second product match each other, based on the first code information of the first product 201 and the second code information of the second product 202. For example, a manner of generating code information according to the third manner 823 may be replaced with the description related to FIG. 5.

In the second operation 820, a fourth manner 824 (heuristics) may be a manner of determining whether the first product 201 and the second product 202 match each other by comparing first identification information (e.g., the first identification information 611 of FIG. 6) for the first product 201 and second identification information (e.g., the second identification information 612 of FIG. 6) for the second product 202 with each other in a situation in which metadata (e.g., the identification information 302) between the first product 201 and the second product 202 does not match. The first identification information 611 and the second identification information 612 may be determined based on at least one character and at least one numeral. For example, in comparing the first identification information 611 and the second identification information 612, the processor 120 may determine whether the first product 201 and the second product 202 match each other by using a first matching condition (prefix match) (e.g., the first matching condition 641 of FIG. 6), a second matching condition (ANS match) (e.g., the second matching condition 642 of FIG. 6), and a third matching condition (CHAR match) (e.g., the third matching condition 643 of FIG. 6). The processor 120 may manage the first product 201 and the second product 202 so that the first product and the second product match each other by using the first matching condition 641, the second matching condition 642, and the third matching condition 643 illustrated in FIG. 6. For example, a manner (e.g., the fourth manner 824) of using a matching condition between the first product 201 and the second product 202 may be replaced with the description related to FIGS. 6 and 7.

According to an embodiment, the electronic device 101 may manage the object embedding model by periodically or aperiodically performing the first operation 810 and the second operation 820 included in the first processing process 801. The processor 120 may select at least one second product 202 which matches the first product 201, based on the object embedding model, and provide the selected second product 202 to the user.

In the second processing process 802, a third operation 830 (e.g., similar object search) and a fourth operation 840 (e.g., search result) may be distinguished, and by performing the third operation 830 and the fourth operation 840, at least one second product 202 may be selected based on the object embedding model. The electronic device 101 may provide the selected at least one second product 202 to the user.

Referring to FIG. 8, the processor 120 of the electronic device 101 may perform the third operation 830 in response to a product search request. For example, the processor 120 may identify the first product 201 according to the product search request, and may select the second product 202 which is at least partially similar to the first product 201, based on the object embedding model. In operation 852, the processor 120 may obtain information related to the second product 202 selected by the object embedding model. The processor 120 may determine at least one second product 202 having a relatively high similarity (e.g., a high degree of relevance), based on the obtained information related to the second product 202. In operation 853, the processor 120 may send information on the determined at least one second product 202 as a reply to the object embedding model, and may update the object embedding model. For example, the object embedding model may autonomously update information related to the first product 201 and information related to the second product 202 which matches the first product 201. The object embedding model may also change a priority of the second product 202 which matches the first product 201. In operation 854, the processor 120 may perform the fourth operation 840, based on the information on the determined at least one second product 202. For example, in response to a product search request for the first product 201, the processor 120 may determine at least one second product 202, and may display the determined at least one second product 202 as a search result through a display (e.g., the display 160 of FIG. 3). The processor 120 may provide, to the user, a second product (e.g., a similar product or an alternative product) which is at least partially similar to the first product 201.

According to an embodiment, the processor 120 may display the first product 201 and the at least one second product 202 through one screen, based on a user interface (UI) based on a similar product recommendation program. The electronic device 101 may select at least one second product 202 having a relatively high similarity with respect to the first product 201, and may provide the selected at least one second product 202 to the user.

According to an embodiment, the electronic device 101 may select a second product 202 (e.g., a similar product or a recommended product) having a relatively high similarity to the first product 201 by using the object embedding model, and may provide the selected second product to the user more efficiently.

A method for recommending a similar product by an electronic device according to an embodiment may include identifying a first product (e.g., the first product 201 of FIG. 2) in response to a search request related to at least one product, identifying identification information (e.g., the identification information 302 of FIG. 3) of a category related to the first product 201, based on an object embedding model, with respect to multiple objects included in the identification information 302, identifying array information of the multiple objects within the identification information 302, searching for at least one second product 202 related to the first product 201, based on the array information of the multiple objects, and outputting information related to the first product 201 and the searched at least one second product 202.

According to an embodiment, the searching for of the at least one second product 202 may include calculating a similarity corresponding to the at least one second product 202, based on the array information of the multiple objects, and searching for the at least one second product 202, based on the calculated similarity.

According to an embodiment, each of the objects included in the identification information 302 may include one of at least one character, at least one numeral, and at least one symbol.

The method for recommending a similar product by the electronic device according to an embodiment may further include: configuring a weight corresponding to each of the objects included in the identification information 302; and in response to a situation in which first code information corresponding to the first product 201 and second code information corresponding to the second product 202 at least partially match each other, applying the configured weight to the matched code information.

According to an embodiment, each of the multiple objects may include information related to the at least one product, the information indicating at least one of category information of the product, type information of the product, option information of the product, function information of the product, color information of the product, manufacturing date information of the product, and manufacturing country information of the product.

According to an embodiment, the searching for of the at least one second product 202 may include, when a first object is not included in the multiple objects, identifying a second object related to the first object, based on the object embedding model, and searching for the at least one second product 202 which is at least partially matched to the identified second object, based on the object embedding model.

According to an embodiment, the searching for of the at least one second product 202 may include identifying a weight configured based on array information for each of the objects, applying the configured weight to each of the multiple objects, and searching for the at least one second product 202, based on the similarity according to the configured weight.

The method for recommending a similar product by the electronic device according to an embodiment may further include, in response to information related to the at least one second product 202 being output, updating the object embedding model, based on the at least one second product 202.

The method for recommending a similar product by the electronic device according to an embodiment may further include transmitting, to an external electronic device 108 through a communication circuit 190, product information related to the first product 201, receiving at least one second product 202 related to the first product 201, the at least one second product being searched based on the object embedding model of the external electronic device 108, and outputting information related to the received at least one second product 202.

In a non-transitory computer-readable storage medium storing one or more programs for executing a method for recommending a similar product by an electronic device 101, the one or more programs, when executed by a processor 120 of the electronic device 101, may include operations of identifying a first product 201 in response to a search request related to at least one product, identifying identification information 302 of a category related to the first product 201, based on an object embedding model, with respect to multiple objects included in the identification information 302, identifying array information of the multiple objects within the identification information 302, searching for at least one second product 202 related to the first product 201, based on the array information of the multiple objects, and outputting information related to the first product 201 and the searched at least one second product 202.

According to an embodiment, the searching for of the at least one second product 202 may include calculating a similarity corresponding to the at least one second product 202, based on the array information of the multiple objects, and searching for the at least one second product 202, based on the calculated similarity.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. It is intended that features described with respect to separate embodiments, or features recited in separate claims, may be combined unless such a combination is explicitly specified as being excluded or such features are incompatible. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
one or more processors operatively connected to the display and the memory, wherein the instructions, when executed by the one or more processors individually or collectively, cause the electronic device to:
identify a first product, in response to a search request related to at least one product,
identify identification information of a category related to the first product, based on an object embedding model,
for multiple objects included in the identification information, identify array information of the multiple objects within the identification information,
search for at least one second product related to the first product, based on the array information of the multiple objects, and
output, through the display, information related to the searched at least one second product.

2. The electronic device of claim 1, wherein the instructions, when executed by the one or more processors individually or collectively, further cause the electronic device to:
calculate a similarity corresponding to the at least one second product, based on the array information of the multiple objects; and
search for the at least one second product, based on the calculated similarity.

3. The electronic device of claim 1, wherein each of the objects included in the identification information is configured to comprise one of at least one character, at least one numeral, and at least one symbol.

4. The electronic device of claim 1, wherein the instructions, when executed by the one or more processors individually or collectively, further cause the electronic device to:
configure a weight corresponding to each of the objects included in the identification information; and
in response to a situation in which first code information corresponding to the first product and second code information corresponding to the second product at least partially match each other, apply the configured weight to the matched code information.

5. The electronic device of claim 1, wherein each of the multiple objects comprises information related to the at least one product, the information indicating at least one of category information of the product, type information of the product, option information of the product, function information of the product, color information of the product, manufacturing date information of the product, and manufacturing country information of the product.

6. The electronic device of claim 1, wherein the instructions, when executed by the one or more processors individually or collectively, further cause the electronic device to:
in case that a first object is not included in the multiple objects, identify a second object related to the first object, based on the object embedding model; and
based on the object embedding model, search for the at least one second product which at least partially matches the identified second object.

7. The electronic device of claim 1, wherein the instructions, when executed by the one or more processors individually or collectively, further cause the electronic device to:
identify a weight configured based on the array information for each of the objects;
apply the configured weight to each of the multiple objects; and
search for the at least one second product, based on a similarity according to the configured weight.

8. The electronic device of claim 1, wherein the instructions, when executed by the one or more processors individually or collectively, further cause the electronic device to:
in response to outputting the information related to the at least one second product, update the object embedding model, based on the at least one second product.

9. The electronic device of claim 1, further comprising:
a communication circuit configured to establish a communication connection with an external electronic device,
wherein the instructions, when executed by the one or more processors individually or collectively, further cause the electronic device to:
transmit, through the communication circuit, product information related to the first product to the external electronic device,
receive at least one second product related to the first product, the at least one second product being searched based on an object embedding model of the external electronic device, and
output information related to the received at least one second product.

10. The electronic device of claim 1, wherein the instructions, when executed by the one or more processors individually or collectively, further cause the electronic device to:
identify the first product, based on at least one of a description, text information, category information, and identification information corresponding to the at least one product according to the search request.

11. A method for recommending a similar product by an electronic device, the method comprising:
identifying a first product in response to a search request related to at least one product;
identifying identification information of a category related to the first product, based on an object embedding model;
for multiple objects included in the identification information, identifying array information of the multiple objects within the identification information;
searching for at least one second product related to the first product, based on the array information of the multiple objects; and
outputting information related to the first product and the searched at least one second product.

12. The method of claim 11, wherein the searching of the at least one second product comprises:
calculating a similarity corresponding to the at least one second product, based on the array information of the multiple objects; and
searching for the at least one second product, based on the calculated similarity.

13. The method of claim 11, further comprising:
configuring a weight corresponding to each of the objects included in the identification information; and
in response to a situation in which first code information corresponding to the first product and second code information corresponding to the second product at least partially match each other, applying the configured weight to the matched code information.

14. The method of claim 11, wherein the searching of the at least one second product comprises:
in case that a first object is not included in the multiple objects, identifying a second object related to the first object, based on the object embedding model; and
based on the object embedding model, searching for the at least one second product which at least partially matches the identified second object.

15. The method of claim 11, wherein each of the objects included in the identification information is configured to comprise one of at least one character, at least one numeral, and at least one symbol.

16. The method of claim 11, wherein each of the multiple objects comprises information related to the at least one product, the information indicating at least one of category information of the product, type information of the product, option information of the product, function information of the product, color information of the product, manufacturing date information of the product, and manufacturing country information of the product.

17. The method of claim 11, further comprising:
identifying a weight configured based on the array information for each of the objects;
applying the configured weight to each of the multiple objects; and
searching for the at least one second product, based on a similarity according to the configured weight.

18. The method of claim 11, further comprising:
in response to outputting the information related to the at least one second product, updating the object embedding model, based on the at least one second product.

19. One or more non-transitory computer-readable storage media storing one or more programs including computer-executable instructions for executing a method for recommending a similar product by an electronic device that, when executed by one or more processors of the electronic device individually or collectively, cause the electronic device to perform operations, the operations comprising:
identifying a first product in response to a search request related to at least one product;
identifying identification information of a category related to the first product, based on an object embedding model;
for multiple objects included in the identification information, identifying array information of the multiple objects within the identification information;
searching for at least one second product related to the first product, based on the array information of the multiple objects; and
outputting information related to the first product and the searched at least one second product.

20. The one or more non-transitory computer-readable storage media of claim 19, the operations further comprising:
calculating a similarity corresponding to the at least one second product, based on the array information of the multiple objects; and
searching for the at least one second product, based on the calculated similarity.
